(19) United States
(12) Patent Application Publication
(10) Pub. No.: US 2018/0059811 A1
(43) Pub. Date: Mar. 1, 2018

(54) DISPLAY CONTROL DEVICE, DISPLAY CONTROL METHOD, AND RECORDING MEDIUM

(71) Applicant: SONY CORPORATION, TOKYO (JP)

(72) Inventor: SEIJI SUZUKI, KANAGAWA (JP)

(21) Appl. No.: 15/559,873

(22) PCT Filed: Jan. 22, 2016
(86) PCT No.: PCT/JP2016/051790

§ 371 Date: Sep. 20, 2017

(30) Foreign Application Priority Data
Mar. 31, 2015 (JP) 2015-073743

(51) Int. Cl. G06F 3/0346; G06F 3/0485; G06F 3/01; G06F 3/0484

(52) U.S. Cl. CPC G06F 3/0346; G06F 3/0485; G06F 2203/04803; G06F 3/04845; G06F 3/017

(57) ABSTRACT

[Object] To give a user feedback indicating that a position outside a display area has been designated in a case where a position designated by the user is outside the display area.

[Solution] There is provided a display control device including: a detecting unit configured to detect an intersection point of a vector designated by a user and a plane including a display area as a designated position; and a display control unit configured to perform display control on the basis of the designated position. The display control unit performs predetermined display control in a case where the designated position is outside the display area.

### TECHNICAL FIELD

The present disclosure relates to a display control device, a display control method, and a recording medium.

### BACKGROUND ART

In recent years, a technique of detecting an intersection point of a vector designated by a user and a display area as a designated position and performing display control according to the designated position has been disclosed. For example, a technique of detecting a hand area of a user from an image captured by a camera, extracting a shadow part from the hand area, detecting a plurality of edges of the shadow part as line segments using a Hough transform, and detecting a position of an intersection point forming an acute angle as a position designated by the user from the detected line segments is disclosed (for example, see Patent Literature 1).

### CITATION LIST

### Patent Literature

Patent Literature 1: JP 2008-59283A

### DISCLOSURE OF INVENTION

### Technical Problem

However, when the position designated by the user is outside a display area, it is desirable to give the user feedback indicating that a position outside the display area has been designated.

### Solution to Problem

According to the present disclosure, there is provided a display control device including: a detecting unit configured to detect an intersection point of a vector designated by a user and a plane including a display area as a designated position; and a display control unit configured to perform display control on the basis of the designated position. The display control unit performs predetermined display control in a case where the designated position is outside the display area.

Further, according to the present disclosure, there is provided a display control method including: detecting an intersection point of a vector designated by a user and a plane including a display area as a designated position; performing display control on the basis of the designated position; and performing predetermined display control is performed in a case where the designated position is outside the display area.

Further, according to the present disclosure, there is provided a computer readable recording medium having a program stored therein, the program causing a computer to function as a display control device including a detecting unit configured to detect an intersection point of a vector designated by a user and a plane including a display area as a designated position, and a display control unit configured to perform display control on the basis of the designated position. The display control unit performs predetermined display control in a case where the designated position is outside the display area.

### Advantageous Effects of Invention

As described above, according to the present disclosure, when the position designated by the user is outside a display area, it is possible to give the user feedback indicating that a position outside the display area has been designated. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an overview of an information processing system according to an embodiment of the present disclosure.

FIG. 2 is a diagram illustrating an exemplary functional configuration of a display control device according to the embodiment.

FIG. 3 is a diagram illustrating an example in which a direction from an elbow to a wrist of the user U is applied as a vector designated by the user.

FIG. 4 is a diagram illustrating an example in which a direction from an elbow to a fingertip of the user U is applied as a vector designated by the user.

FIG. 5 is a diagram for describing an example of detecting an intersection point of a designated vector and a plane including a display area as a designated position.

FIG. 6 is a diagram illustrating a first display control example when a designated position is outside a display area.

FIG. 7 is a diagram illustrating a second display control example when a designated position is outside a display area.

FIG. 8 is a diagram illustrating a third display control example when a designated position is outside a display area.

FIG. 9 is a flowchart illustrating an example of a flow of an operation of causing an object to be displayed on a display area when a designated position is outside a display area.

FIG. 10 is a diagram illustrating a fourth display control example when a designated position is outside a display area.

FIG. 11 is a flowchart illustrating an example of a flow of an operation for correcting a designated position when a designated position is outside a display area.

FIG. 12 is a diagram illustrating a fifth display control example when a designated position is outside a display area.

FIG. 13 is a flowchart illustrating an example of a flow of an operation of scrolling content on the basis of a designated position when a designated position is outside a display area.

FIG. 14 is a diagram illustrating a sixth display control example when a designated position is outside a display area.

FIG. 15 is a diagram illustrating a seventh display control example when a designated position is outside a display area.

FIG. 16 is a diagram illustrating an eighth display control example when a designated position is outside a display area.

FIG. 17 is a flowchart illustrating an example of a flow of an operation of processing content on the basis of movement of a designated position.

FIG. 18 is a diagram for describing an example in which a designated vector is applied on the basis of sensor data detected by a sensor.

FIG. 19 is a diagram for describing an example in which a designated vector is applied on the basis of sensor data detected by a sensor.

FIG. 20 is a view illustrating an exemplary hardware configuration of a display control device according to an embodiment of the present disclosure.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that, in this description and the drawings, structural elements that have substantially the same function and structure are sometimes distinguished from each other using different alphabets or numerals after the same reference sign. However, when there is no need in particular to distinguish structural elements that have substantially the same function and structure, the same reference sign alone is attached.

Further, description will proceed in the following order.

### 1. Embodiment

1-1. Overview of information processing system
1-2. Exemplary functional configuration of display control device
1-3. Example of designated vector calculation
1-4. Calibration data
1-5. Display control example according to designated position
1-6. Another example of designated vector calculation
1-7. Exemplary hardware configuration

### 2. Conclusion

### 1. Embodiment

### [1-1. Overview of Information Processing System]

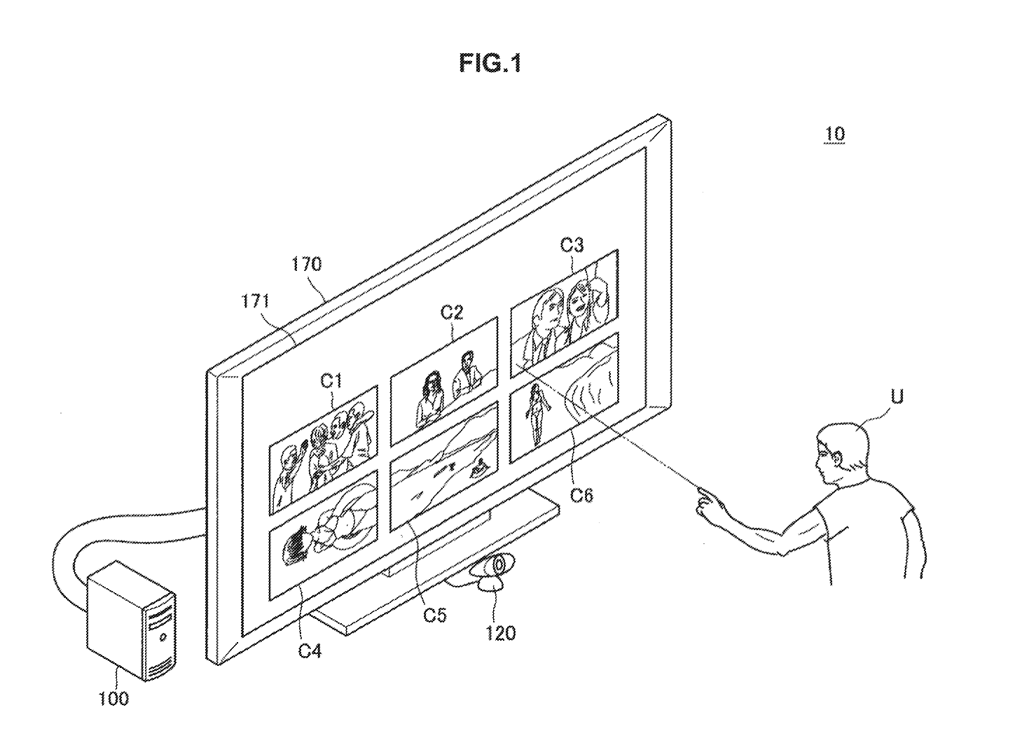

First, an overview of an information processing system 10 according to an embodiment of the present disclosure will be described. FIG. 1 is a diagram for describing an overview of the information processing system 10 according to an embodiment of the present disclosure. As illustrated in FIG. 1, the information processing system 10 includes a display control device 100, a detecting device 120, and a display device 170.

The detecting device 120 is a camera module that captures an image. The detecting device 120 images a real space using an imaging element such as a charge coupled device (CCD) or a complementary metal oxide semiconductor (CMOS), and generates an image. The image generated by the detecting device 120 is output to the display control device 100. In the example illustrated in FIG. 1, the detecting device 120 is configured separately from the display control device 100, but the detecting device 120 may be integrated with the display control device 100.

The display device 170 displays various kinds of information on a display area 171 in accordance with control by the display control device 100. The display device 170 is configured with, for example, a liquid crystal display (LCD), an organic electroluminescence (EL) display device, or the like. In the example illustrated in FIG. 1, the display device 170 is configured separately from the display control device 100, but the display device 170 may be integrated with the display control device 100. The display device 170 includes the display area 171, and the display control device 100 causes content C1 to C6 to be displayed on the display area 171.

Here, a technique of detecting an intersection point of the designated vector by a user U and the display area 171 as a designated position and performing display control in accordance with the designated position is known. For example, when any one of the content C1 to C6 exists at the intersection point of the designated vector and the display area 171 during more than a predetermined time, the content in which the intersection point exists during more than the predetermined time may be enlarged and displayed (a slideshow of the content in which the intersection point exists during more than the predetermined time may start).

However, when the position designated by the user U is outside the display area 171, it is desirable to give a feedback indicating that a position outside the display area 171 is designated to the user U. Such feedback is considered to be useful for the user U who desires to designate a position inside the display area 171 and be useful for the user U who desires to designate a position outside the display area 171 as well. In this specification, a technique for performing such feedback will be mainly described.

The following description will proceed with an example in which the display control device 100 is applied to a personal computer (PC), but the display control device 100 may be applied to devices other than the PC. For example, the display control device 100 may be applied to video cameras, digital cameras, personal digital assistants (PDA), tablet terminals, smartphones, mobile phones, portable music reproducing devices, portable video processing device, portable game machines, television devices, digital signage, or the like.

The overview of the information processing system 10 according to an embodiment of the present disclosure has been described above.

### [1-2. Exemplary Functional Configuration of Display Control Device]

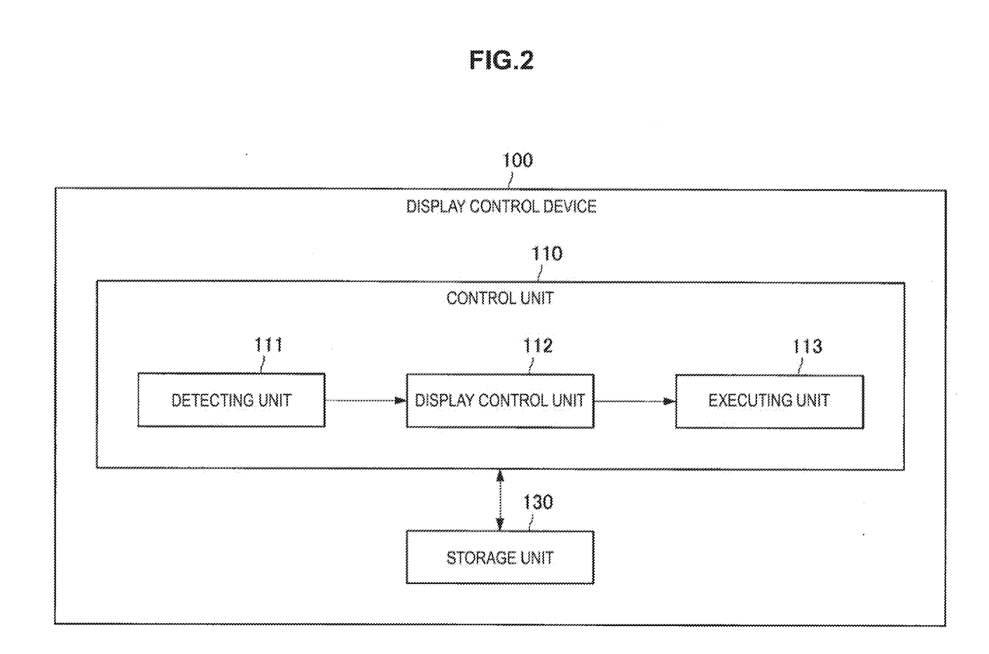

Next, an exemplary functional configuration of the display control device 100 according to an embodiment of the present disclosure will be described. FIG. 2 illustrates an exemplary functional configuration of the display control device 100 according to an embodiment of the present disclosure. As illustrated in FIG. 2, the display control device 100 includes a control unit 110 and a storage unit 130.

The control unit 110 corresponds to, for example, a processor such as a central processing unit (CPU) or a digital signal processor (DSP). The control unit 110 performs various functions included in the control unit 110 by executing a program stored in the storage unit 130 or another storage medium. The control unit 110 includes functional blocks such as a detecting unit 111, a display control unit 112, and an executing unit 113. Functions of the functional blocks will be described later.

The storage unit 130 stores a program for operating the control unit 110 using a storage medium such as a semiconductor memory or a hard disk. Further, for example, the storage unit 130 is able to also store various kinds of data used by a program (for example, an image or the like). In the example illustrated in FIG. 2, the storage unit 130 is integrated with the display control device 100, but the storage unit 130 may be configured separately from the display control device 100.

The exemplary functional configuration of the display control device 100 according to an embodiment of the present disclosure has been described above.

### [1-3. Example of Designated Vector Calculation]

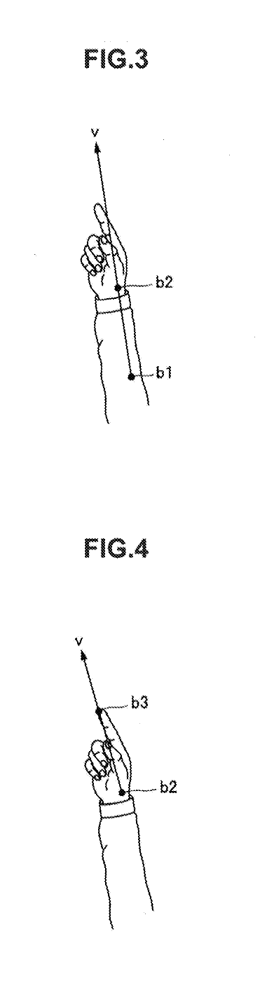

First, the designated vector by the user U can be applied by an any method, but an example in which the designated vector by the user U is applied by finger pointing of the user will be described. FIG. 3 illustrates an example in which a direction from an elbow to a wrist of the user U is applied as the designated vector by the user U. As illustrated in FIG. 3, the detecting unit 111 three-dimensionally recognizes skeletal information of the user U from an image captured by the detecting device 120. Then, when positions of an elbow b1 and a wrist b2 are acquired from the three-dimensionally recognized skeletal information, the detecting unit 111 is able to detect the direction from the elbow b1 to the wrist b2 as a designated vector v.

FIG. 4 is a diagram illustrating an example in which the direction from an elbow to a fingertip of the user U is applied as the designated vector by the user U. FIG. As illustrated in FIG. 4, the detecting unit 111 three-dimensionally recognizes the skeletal information of the user U from the image captured by the detecting device 120. Then, when positions of the wrist b2 and a fingertip b3 are acquired from the three-dimensionally recognized skeletal information, the detecting unit 111 is able to detect the direction from the wrist b2 to the fingertip b3 as a designated vector v.

Here, when the direction from the wrist b2 to the fingertip b3 is detected as the designated vector v, the designated vector v is considered to be able to be calculated with higher accuracy than when the direction from the elbow b1 to the wrist b2 is detected as the designated vector v. As in the above examples, either of the direction from the wrist b2 to the fingertip b3 and the direction from the elbow b1 to the wrist b2 may be used as the designated vector v, but an average of the direction from the wrist b2 to the fingertip b3 and the direction from the elbow b1 to the wrist b2 may be used as the designated vector v.

### [1-4. Calibration Data]

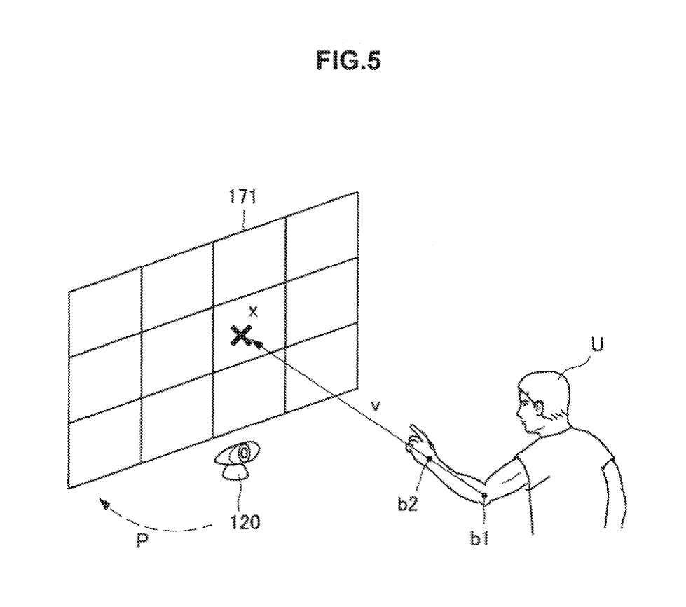

Next, the detecting unit 111 detects the intersection point of the designated vector v and the plane including the display area 171 as the designated position. FIG. 5 is a diagram for describing an example of detecting the intersection point of the designated vector v and the plane including the display area 171 as the designated position. For example, when a scale variable is indicated by “t,” coordinates of the wrist b2 is indicated by “p,” and a projection matrix from the detecting device 120 to the display device 170 is indicated by “P,” the detecting unit 111 is able to calculate an intersection point x of the designated vector v and the plane including the display area 171 using the following Formula (1).

X=P(tv+p) (1)

At this time, when a relative positional relation between the detecting device 120 and the display device 170 is decided (for example, when the detecting device 120 is incorporated into a predetermined position of the display device 170), the projection matrix P which is decided in advance may be used. On the other hand, when the relative positional relation between the detecting device 120 and the display device 170 is not decided (for example, when the display device 170 and the detecting device 120 are separately installed or when the detecting device 120 is embedded in a projector), calibration may be performed by the display control device 100 (a projective transformation P may be calculated).

For example, finger pointing may be sequentially performed by the user U on a total of five points including four corners of the display area 171 and the center of the display area 171, and calibration may be performed on the basis of the finger pointing by the user U toward the five points. Further, an object displayed on the display area 171 may be read by a camera fixed to the detecting device 120, and calibration may be executed on the basis of the position of the read object. The calibration data which has been calculated once can be continuously used unless the positional relation between the detecting device 120 and the display device 170 is changed.

### [1-5. Display Control Example According to Designated Position]

Next, the display control unit 112 performs display control on the basis of the designated position. Then, the display control unit 112 performs predetermined display control when the designated position is outside the display area 171. Through this configuration, when the position designated by the user U is outside the display area 171, it is possible to give a feedback indicating that a position outside the display area 171 is designated to the user U. The predetermined display control is not particularly limited. An example of the predetermined display control will be described below.

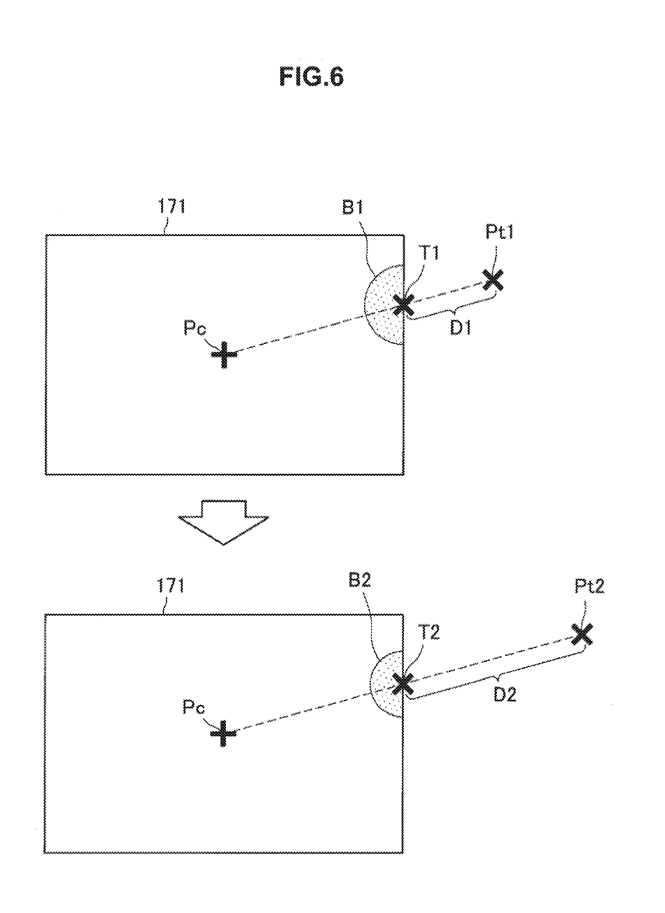

FIG. 6 is a diagram illustrating a first display control example when the designated position is outside the display area 171. Referring to FIG. 6, the center of the display area 171 is illustrated as a center position Pc. Here, the display control unit 112 may cause an object to be displayed on the display area 171 when the designated position is outside of the display area 171. Accordingly, it is possible to visually inform the user U that a position outside the display area 171 is designated. In the example illustrated in FIG. 6, since a designated position Pt1 which is outside of the display area 171 is designated by the user U, the display control unit 112 causes an object B1 to be displayed on the display area 171.

The object displayed on the display area 171 may be anything as long as it is visible by the user U, and a color, a size, a shape, or the like of the object are not particularly limited. Further, a display position of the object is not particularly limited, but for example, the display control unit 112 may cause the object to be displayed on an end portion of the display area 171 when the designated position is outside the display area 171. Accordingly, it is possible to more intuitively inform the user U that a position outside the display area 171 is designated. In the example illustrated in FIG. 6, since the designated position Pt1 is outside the display area 171, the display control unit 112 causes the object B1 to be displayed on the end portion of the display area 171.

Particularly, when the designated position is outside the display area 171, the display control unit 112 may cause the object to be displayed at an intersection point of the end portion of the display area 171 and a line segment connecting a predetermined position (for example, the center position Pc) of the display area 171 with the designated position. Accordingly, it is possible to inform the user U of a direction of the designated position by the user U with reference to the position of the display area 171. In the example illustrated in FIG. 6, since the designated position Pt1 is outside the display area 171, the display control unit 112 causes the object B1 to be displayed at an intersection point T1 of the end portion of the display area 171 and a line segment connecting a predetermined position (for example, the center position Pc) of the display area 171 with the designated position Pt1.

The following description will proceed with an example in which the predetermined position of the display area 171 is the center position Pc, but the predetermined position of the display area 171 is not limited to the center position Pc.

Further, the display control unit 112 may cause the same object to be displayed on the display area 171 without depending on the designated position or may change the object in accordance with the designated position. For example, the display control unit 112 may change the size of the object in accordance with the designated position. Referring to FIG. 6, since a designated position Pt2 is outside the display area 171, the display control unit 112 causes an object B2 to be displayed at an intersection point T2 of the end portion of the display area 171 and a line segment connecting the center position Pc of the display area 171 with the designated position.

In the example illustrated in FIG. 6, since a distance D1 from the intersection point T1 to the designated position Pt1 is smaller than a distance D2 from the intersection point T2 to the designated position Pt2, the display control unit 112 causes the size of the object B1 to be larger than the size of the object B2. As described above, the display control unit 112 may increase the size of the object as the distance from the intersection point of the end portion of the display area 171 and the line segment connecting the center position Pc of the display area 171 with the designated position to the designated position decreases, but a method of changing the size of the object is not limited. Therefore, the display control unit 112 may decrease the size of the object as the distance from the intersection point to the designated position decreases.

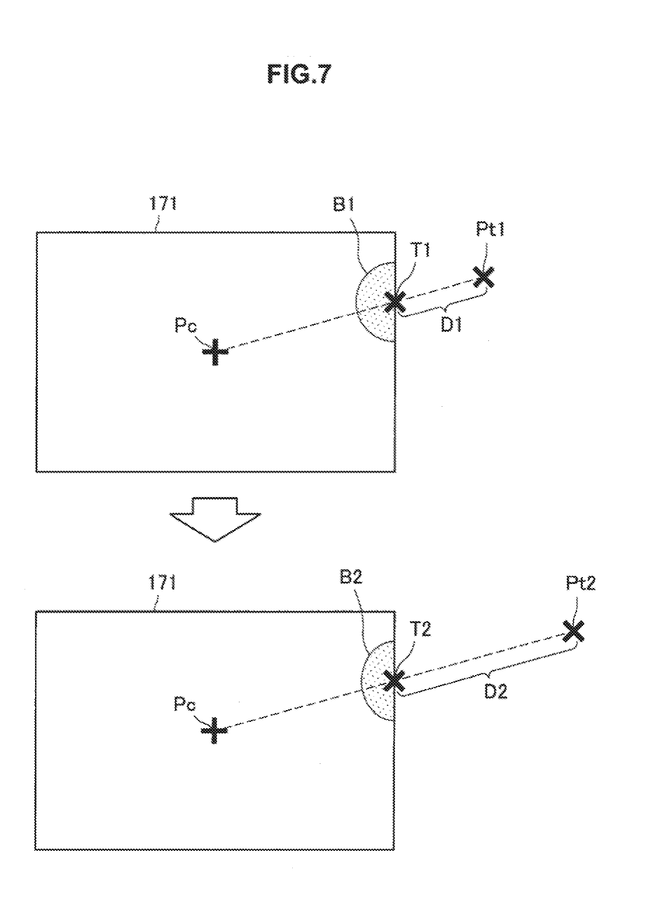

FIG. 7 is a diagram illustrating a second display control example when a designated position is outside the display area 171. The example in which the display control unit 112 changes the size of the object in accordance with the designated position has been described above. However, the display control unit 112 may change the shape of the object in accordance with to the designated position. In the example illustrated in FIG. 7, since the distance D1 from the intersection point T1 to the designated position Pt1 is smaller than the distance D2 from the intersection point T2 to the designated position Pt2, the display control unit 112 decreases a deformation degree of the object B1 to be smaller than a deformation degree of the object B2 (a shape of the object B1 is semicircular, similarly to when the designated position is inside the display area 171, and a shape of the object B2 is semi-elliptical).

As described above, the display control unit 112 may decrease the deformation degree of the object as the distance from the intersection point of the end position of the display area 171 and the line segment connecting the center position Pc of the display area 171 with the designated position to the designated position decreases, but a method of changing the shape of the object is not limited. Therefore, the display control unit 112 may increase the deformation degree of the object as the distance from the intersection point to the designated position decreases.

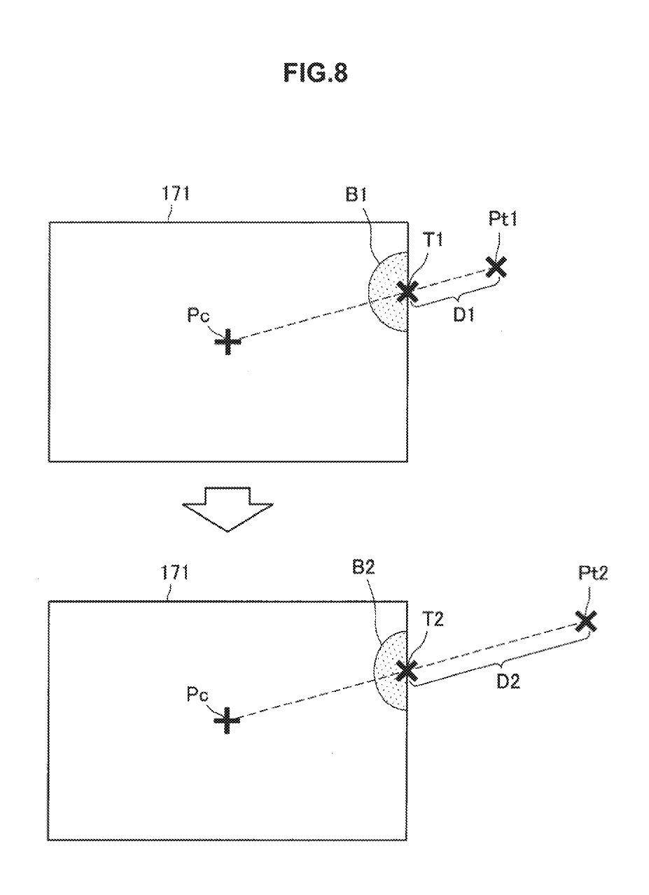

FIG. 8 is a diagram illustrating a third display control example when the designated position is outside the display area 171. The example in which the display control unit 112 changes the shape of the object in accordance with the designated position has been described above. However, the display control unit 112 may change the color of the object in accordance with the designated position. Here, in the example illustrated in FIG. 8, since the distance D1 from the intersection point T1 to the designated position Pt1 is smaller than the distance D2 from the center position Pc of the display area 171 to the designated position Pt2, the display control unit 112 causes the color of the object B1 to be thinner than the color of the object B2.

As described above, the display control unit 112 may cause the color of the object to be thinner as the distance from the intersection point of the end portion of the display area 171 and the line segment connecting the center position Pc of the display area 171 with the designated position to the designated position decreases, but a method of changing the color of the object is not limited. Therefore, as the distance from the center position Pc of the display area 171 to the designated position decreases, the display control unit 112 may cause the color of the object to be darker. Alternatively, the change in the color of the object may not be a change in the density of the color of the object.

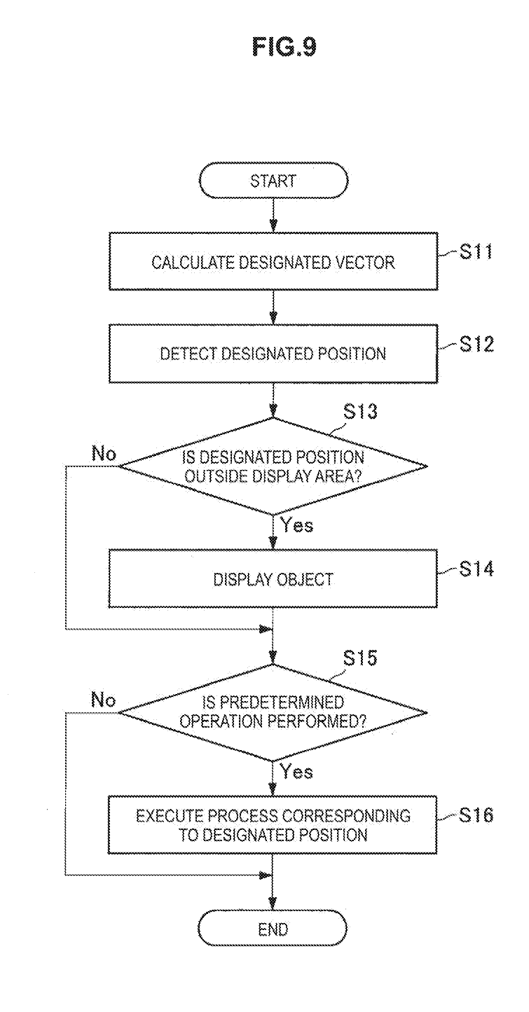

The example in which the object is displayed in the display area 171 when the designated position is outside the display area 171 has been described above. Next, an example of a flow of such operation will be described. FIG. 9 is a flowchart illustrating an example of a flow of an operation of causing the object to be displayed on the display area 171 when the designated position is outside the display area 171. The operation of causing the object to be displayed on the display area 171 when the designated position is outside the display area 171 is not limited to the example illustrated in the flowchart of FIG. 9.

First, the detecting unit 111 calculates the designated vector by the user on the basis of the image captured by the detecting device 120 (S11). Then, the detecting unit 111 detects the intersection point of the designated vector by the user and the plane including the display area 171 as the designated position (S12). Then, the display control unit 112 determines whether or not the designated position is outside the display area 171 (S13). When the designated position is determined not to be outside the display area 171 (No in S13), the display control unit 112 causes the operation to proceed to S15. On the other hand, when the designated position is determined to be outside the display area 171 (Yes in S13), the object is displayed on the display area 171 (S14), and the operation proceeds to S15.

Then, the executing unit 113 determines whether or not a predetermined operation is performed by the user (S15). When the predetermined operation is determined not to be performed by the user (No in S15), the executing unit 113 ends the operation. On the other hand, when the predetermined operation is determined to be performed by the user (Yes in S15), the executing unit 113 executes a process corresponding to the designated position (S16) and then ends the operation. The process corresponding to the designated position is not particularly limited, and as described above, it may be a process of enlarging and displaying the content in which the intersection point of the designated vector by the user U and the display area 171 exists during more than a predetermined time.

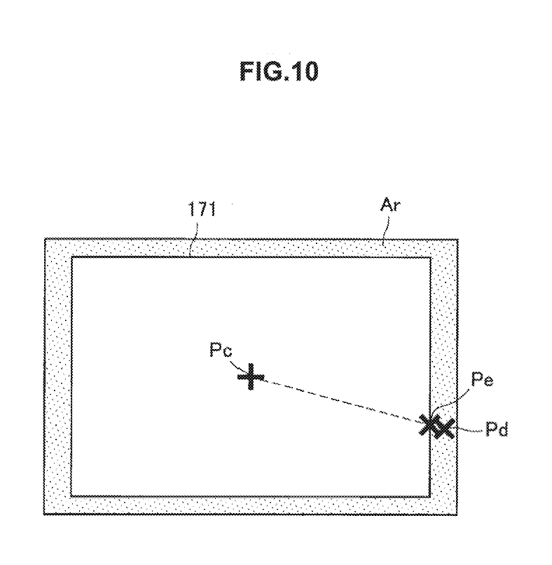

Next, a fourth display control example when the designated position is outside the display area 171 will be described. FIG. 10 is a diagram illustrating a fourth display control example when the designated position is outside the display area 171. The example in which the display control unit 112 causes the object to be displayed on the display area 171 in accordance with the designated position has been described above. However, the display control unit 112 may correct the designated position when the designated position is outside the display area 171. Through this configuration, even when the designated position appears outside the display area 171, the designated position is shifted to the corrected designated position.

The corrected designated position is not limited, but for example, as illustrated in FIG. 10, when a designated position Pd is outside the display area 171, the display control unit 112 may correct the designated position Pd to an intersection point Pe of a line segment connecting the center position Pc with the designated position Pd and the end portion of the display area 171. When the designated position Pd is corrected to the intersection point Pe, the user can easily understand the corrected designated position. A correction area Ar may be set around the display area 171. The display control unit 112 may correct the designated position Pd when the designated position Pd is inside the correction area Ar.

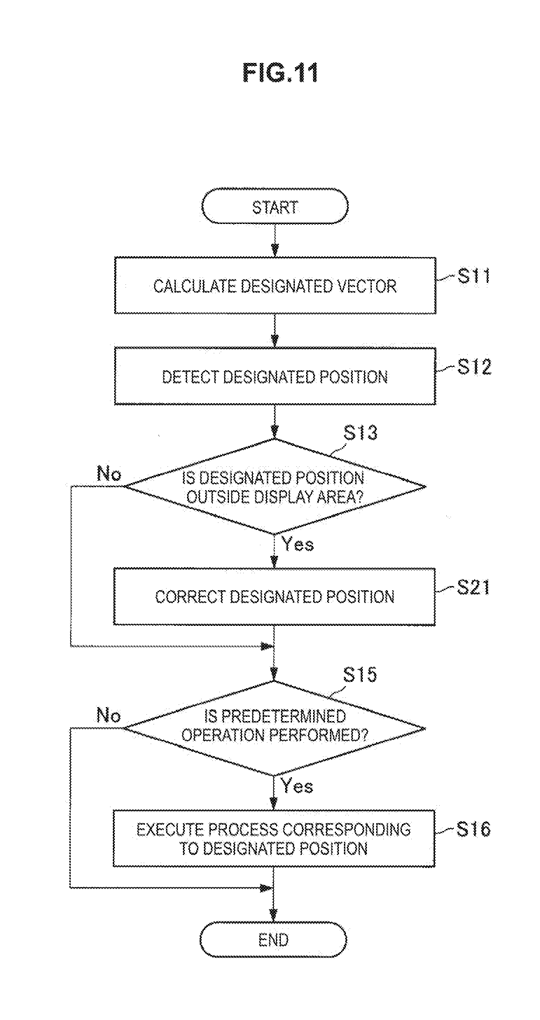

The example in which the designated position is corrected when the designated position is outside the display area 171 has been described above. Next, an example of the flow of such operation will be described. FIG. 11 is a flowchart illustrating an example of the flow of the operation for correcting the designated position when the designated position is outside the display area 171. The operation of correcting the designated position when the designated position is outside the display area 171 is not limited to the example illustrated in the flowchart of FIG. 11.

First, the detecting unit 111 calculates the designated vector by the user on the basis of the image captured by the detecting device 120 (S11). Then, the detecting unit 111 detects the intersection point of the designated vector by the user and the plane including the display area 171 as the designated position (S12). Then, the display control unit 112 determines whether or not the designated position is outside the display area 171 (S13). When the designated position is determined not to be outside the display area 171 (No in S13), the display control unit 112 causes the operation to proceed to S15. On the other hand, when the designated position is determined to be outside the display area 171 (Yes in S13), the designated position is corrected (S21), and the operation proceeds to S15.

Then, the executing unit 113 determines whether or not a predetermined operation is performed by the user (S15). When the predetermined operation is determined not to be performed by the user (No in S15), the executing unit 113 ends the operation. On the other hand, when the predetermined operation is determined to be performed by the user (Yes in S15), the executing unit 113 executes a process corresponding to the designated position (S16) and then ends the operation. The process corresponding to the designated position is not particularly limited, and as described above, it may be a process of enlarging and displaying the content in which the intersection point of the designated vector by the user U and the display area 171 exists during more than a predetermined time.

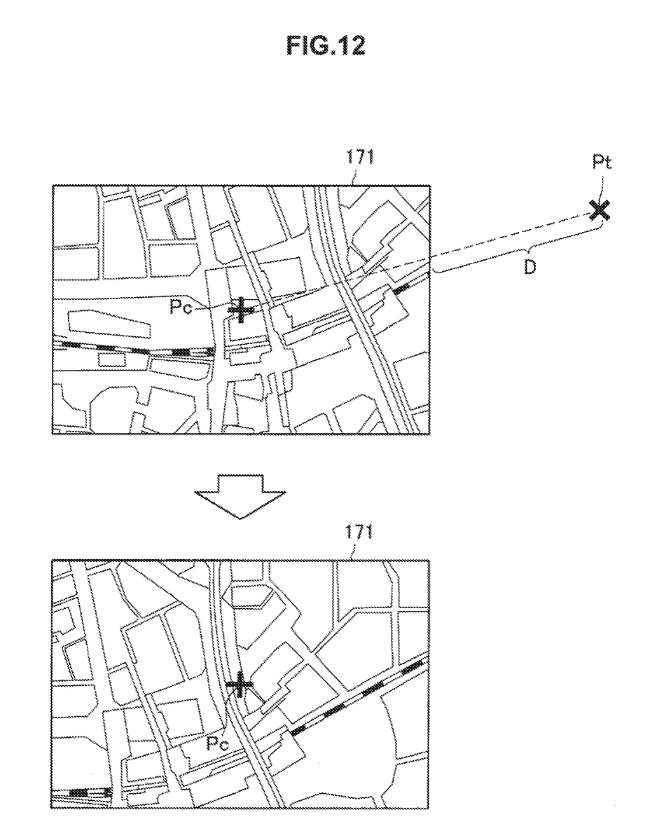

Next, a fifth display control example when the designated position is outside the display area 171 will be described. FIG. 12 is a diagram illustrating a fifth display control example when the designated position is outside the display area 171. The example in which the designated position is corrected when the designated position is outside the display area 171 has been described above. However, when the designated position is outside the display area 171, the display control unit 112 may scroll content of the display area 171 on the basis of the designated position. Through this configuration, it is possible to increase a content scrollable amount.

A content scroll direction is not limited, but for example, as illustrated in FIG. 12, when the designated position Pt is outside the display area 171, the display control unit 112 may scroll the content on the basis of a direction of the designated position Pt with reference to the center position Pc. When the content is scrolled in such a direction, the user can intuitively designate the content scroll direction. FIG. 12 illustrates an example in which map data is content, but the content may not be the map data. For example, the content may be photograph data (may be displayed by a photograph viewer).

A content scroll speed is not limited, but for example, in the display control unit 112, when the designated position Pt is outside the display area 171, the content may be scrolled in accordance with a speed corresponding to the distance D between a reference position of the display area 171 (for example, the intersection point of the end portion of the display area 171 and the line segment connecting the center position Pc of the display area 171 with the designated position Pt) and the designated position Pt. When the content is scrolled at such a speed, the user can intuitively designate the content scroll speed.

A relation between the distance D and the content scroll speed is not limited, but for example, in the display control unit 112, when the designated position is outside the display area, the speed at which the content is scrolled may increase as the distance D between the reference position of the display area 171 and the designated position increases.

Here, the example in which the display control unit 112 scrolls the content of the display area 171 on the basis of the designated position when the designated position is outside the display area 171 has been described. However, when the designated position is outside the display area 171, the display control unit 112 may switch the content of the display area 171 on the basis of the designated position.

A content switching direction is not limited, but when the designated position Pt is outside the display area 171, the display control unit 112 may switch the content on the basis of the direction of the designated position Pt with reference to the center position Pc. Further, a content switching speed is not limited, but for example, in the display control unit 112, when the designated position Pt is outside the display area 171, the content may be switched in accordance with a speed corresponding to the distance D between the reference position of the display area 171 (for example, the intersection point of the end portion of the display area 171 and the line segment connecting the center position Pc of the display area 171 with the designated position Pt) and the designated position Pt.

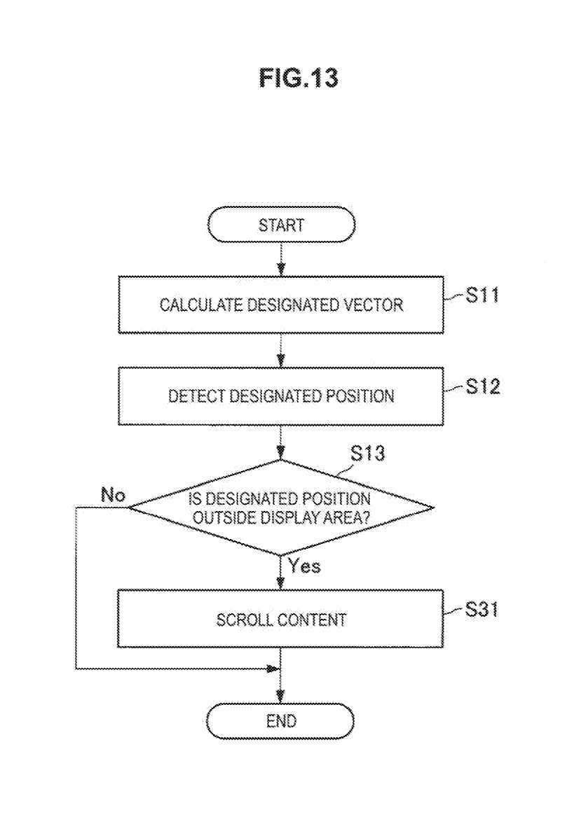

The example in which the content is scrolled on the basis of the designated position when the designated position is outside the display area 171 has been described above. Next, an example of the flow of such operation will be described. FIG. 13 is a flowchart illustrating an example of the flow of the operation of scrolling the content on the basis of the designated position when the designated position is outside the display area 171. The operation of scrolling the content on the basis of the designated position when the designated position is outside the display area 171 is not limited to the example illustrated in the flowchart of FIG. 13.

First, the detecting unit 111 calculates the designated vector by the user on the basis of the image captured by the detecting device 120 (S11). Then, the detecting unit 111 detects the intersection point of the designated vector by the user and the plane including the display area 171 as the designated position (S12). Then, the display control unit 112 determines whether or not the designated position is outside the display area 171 (S13). When the designated position is determined not to be outside of the display area 171 (No in S13), the display control unit 112 ends the operation. On the other hand, when the designated position is determined to be outside the display area 171 (Yes in S13), the content is scrolled on the basis of the designated position (S31), and the operation ends.

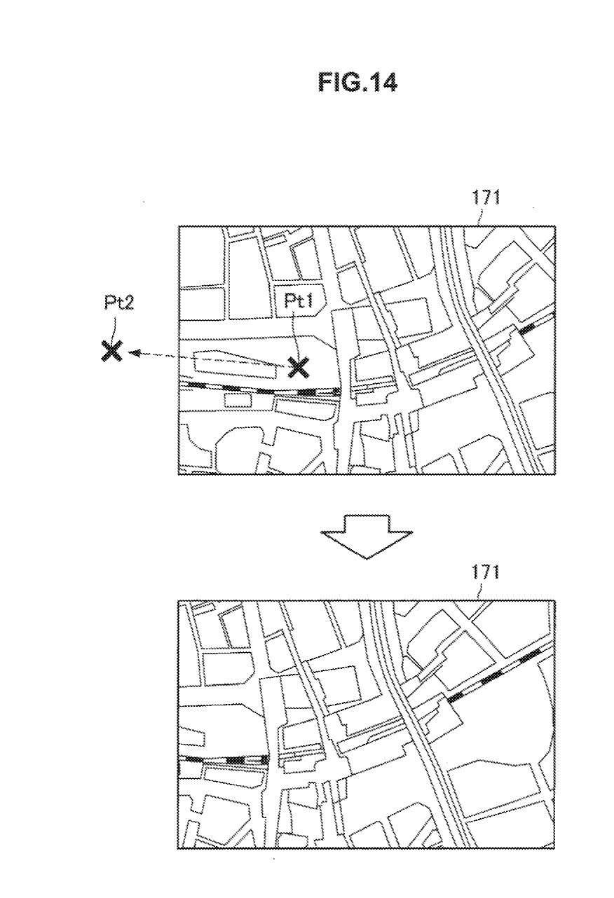

Next, a sixth display control example when the designated position is outside the display area 171 will be described. FIG. 14 is a diagram illustrating a sixth display control example when the designated position is outside the display area 171. The example in which the content is scrolled on the basis of the designated position when the designated position is outside the display area 171 has been described above. However, when the designated position is moved from a position inside the display area 171 to a position outside the display area 171, the display control unit 112 may perform a drag operation on the basis of the movement of the designated position. Through this configuration, it is possible to increase the width of the drag operation.

A direction and a magnitude of the drag operation are not limited, but for example, as illustrated in FIG. 14, when the designated position is moved from a position Pt1 inside the display area 171 to a position Pt2 outside the display area 171, the display control unit 112 may perform the drag operation in accordance with the direction and the magnitude from the position Pt1 to the position Pt2 outside the display area 171. When the drag operation is performed in accordance with the direction and the magnitude, the user can intuitively perform the drag operation.

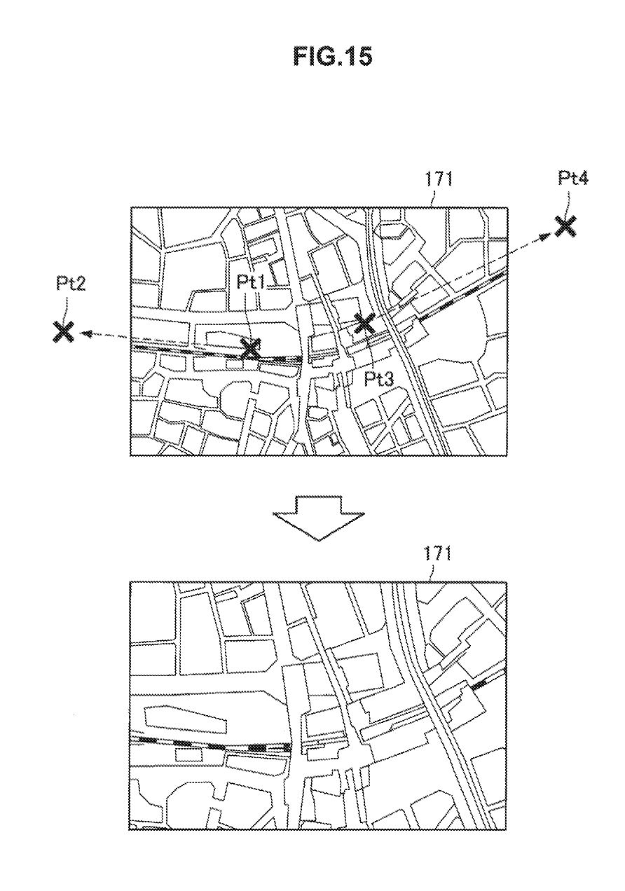

Next, a seventh display control example when the designated position is outside the display area 171 will be described. FIG. 15 is a diagram illustrating a seventh display control example when the designated position is outside the display area 171. The example in which the drag operation is performed on the basis of the movement of the designated position when the designated position is moved from a position inside the display area 171 to a position outside the display area 171 has been described. However, when each of a plurality of designated positions is moved from a position inside the display area 171 to a position outside the display area 171, the display control unit 112 may perform a pinch-out operation on the basis of the movement of each of a plurality of designated positions. Through this configuration, it is possible to increase the width of the pinch-out operation.

An action performed by the pinch-out operation may be an operation of enlarging the content. For example, as illustrated in FIG. 15, when the designated position is moved from a position Pt1 inside the display area 171 to a position Pt2 outside the display area 171, and the designated position is moved from a position Pt3 inside the display area 171 to a position Pt4 outside the display area 171, the display control unit 112 may enlarge the content displayed on the display area 171. When the content is enlarged by the pinch-out operation, the user can intuitively enlarge the content.

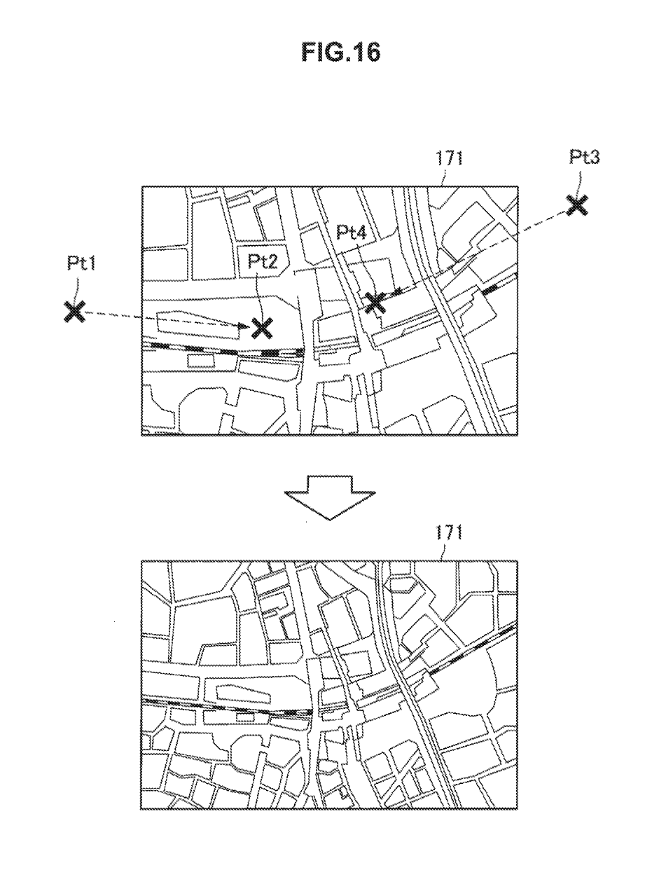

Next, an eighth display control example when the designated position is outside the display area 171 will be described. FIG. 16 is a diagram illustrating an eighth display control example when the designated position is outside the display area 171. The example in which the pinch-out operation is performed on the basis of the movement of each of a plurality of designated positions when each of a plurality of designated positions is moved from a position inside the display area 171 to a position outside the display area 171 has been described above. However, when each of a plurality of designated positions is moved from a position outside the display area 171 to a position inside the display area 171, the display control unit 112 may perform a pinch-in operation on the basis of the movement of each of a plurality of designated positions. Through this configuration, it is possible to increase the width of the pinch-in operation.

An operation performed by the pinch-in operation may be an operation of reducing the content. For example, as illustrated in FIG. 16, when the designated position is moved from a position Pt1 outside the display area 171 to a position Pt2 inside the display area 171, and the designated position is moved from a position Pt3 outside the display area 171 to a position Pt4 inside the display area 171, the display control unit 112 may reduce the content displayed on the display area 171. When the content is reduced by the pinch-in operation, the user can intuitively reduce the content.

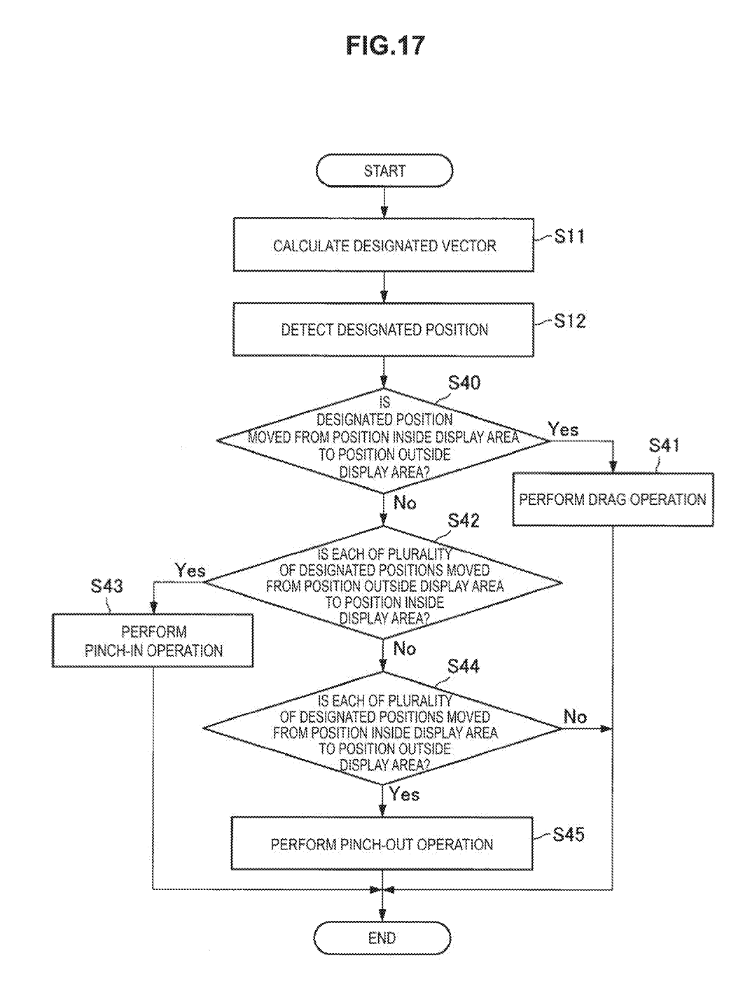

The example in which the operation of processing the content is performed on the basis of the movement of the designated position has been described above. Next, an example of the flow of such operation will be described. FIG. 17 is a flowchart illustrating an example of the flow of the operation for processing the content on the basis of the movement of the designated position. The operation for processing the content on the basis of the movement of the designated position is not limited to the example illustrated in the flowchart of FIG. 17.

First, the detecting unit 111 calculates the designated vector by the user on the basis of the image captured by the detecting device 120 (S11). Then, the detecting unit 111 detects the intersection point of the designated vector by the user and the plane including the display area 171 as the designated position (S12). Then, the display control unit 112 determines whether or not the designated position is moved from a position inside the display area 171 to a position outside the display area 171 (S40).

When the designated position is determined to be moved from a position inside the display area 171 to a position outside the display area 171 (Yes in S40), the display control unit 112 performs the drag operation (S40), and ends the operation. On the other hand, when the designated position is determined not to be moved from a position inside the display area 171 to a position outside the display area 171 (No in S40), the display control unit 112 determines whether or not each of a plurality of designated positions is moved from a position outside the display area 171 to a position inside the display area 171 (S42).

Then, when each of a plurality of designated positions is determined to be moved from a position outside the display area 171 to a position inside the display area 171 (Yes in S42), the display control unit 112 performs the pinch-in operation (S43) and ends the operation. On the other hand, when each of a plurality of designated positions is determined not to be moved from a position outside the display area 171 to a position inside the display area 171 (No in S42), the display control unit 112 determines whether or not each of a plurality of designated positions is moved from a position inside the display area 171 to a position outside the display area 171 (S44).

Then, when each of a plurality of designated positions is determined to be moved from a position inside the display area 171 to a position outside the display area 171 (Yes in S44), the display control unit 112 performs the pinch-out operation (S45) and ends the operation. On the other hand, when each of a plurality of designated positions is determined not to be moved from a position inside the display area 171 to a position outside the display area 171 (No in S44), the display control unit 112 ends the operation.

### [1-6. Another Example of Designated Vector Calculation]

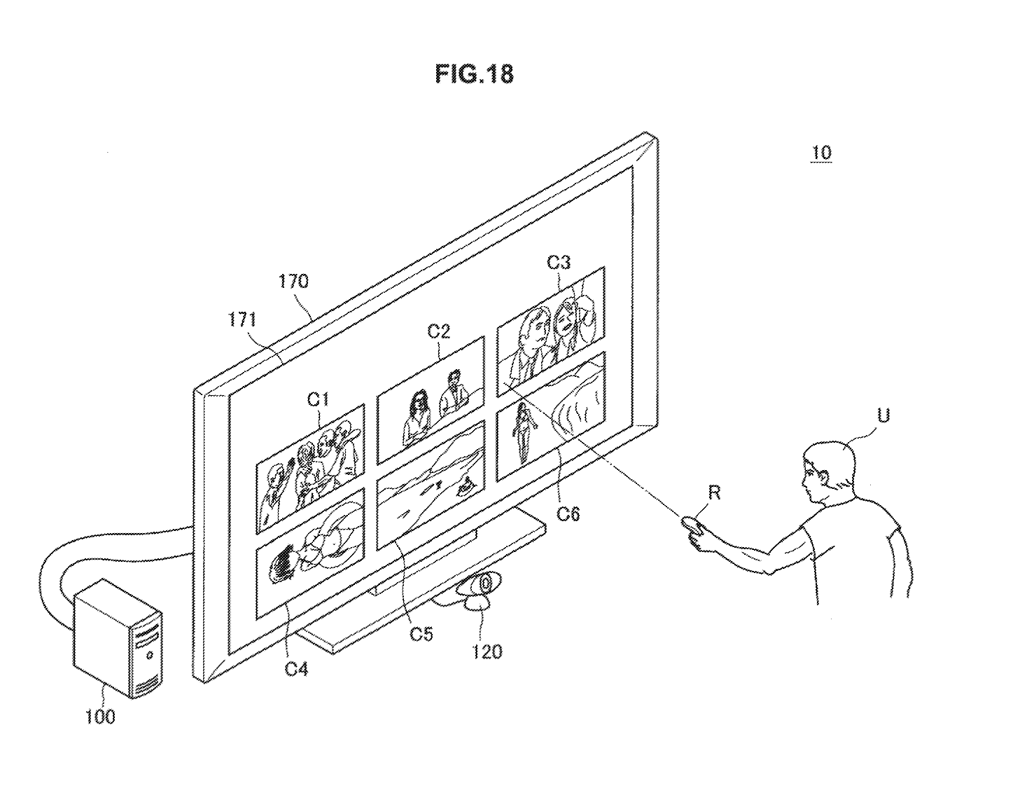

The display control example when the designated position is outside the display area 171 has been described above. Here, as described above, the designated vector by the user U can be applied using any method. For example, in the detecting unit 111, a designated vector may be applied on the basis of sensor data detected by a sensor. FIG. 18 is a diagram for describing an example in which the designated vector is applied on the basis of sensor data detected by a sensor. As illustrated in FIG. 18, the user U can operate a sensor R.

Then, the detecting unit 111 calculates the designated vector on the basis of the sensor data detected by the sensor R, and detects the intersection point of the designated vector and the plane including the display area 171 as the designated position. The sensor data detected by the sensor R may be motion of the sensor R. For example, the sensor data may be acceleration detected by an acceleration sensor or an angular velocity detected by a gyro sensor. For example, a technique disclosed in WO 2009/008372 may be employed as a technique of calculating the intersection point of the designated vector and the display area 171.

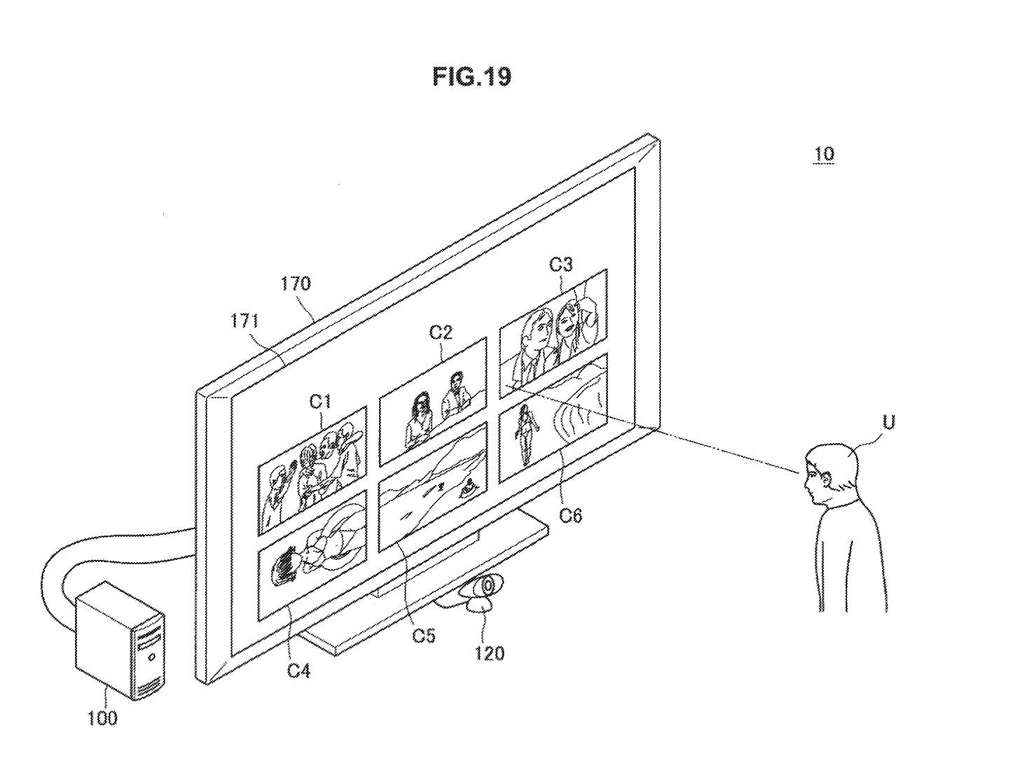

Further, the designated vector may be applied through a line of sight of the user. FIG. 19 is a diagram for describing an example in which the designated vector is applied by the line of sight of the user. As illustrated in FIG. 19, the user U can cast a glance to the display area 171. Here, the detecting unit 111 detects the line of sight of the user U. A technique of detecting the line of sight of the user U is not particularly limited.

For example, when an eye area of the user U is imaged by an imaging device (not illustrated), the detecting unit 111 may detect the line of sight of the user U on the basis of an imaging result obtained by imaging the eye area of the user U. For example, when an infrared camera is used as the imaging device, an infrared irradiating device that irradiates the eye area of the user U with infrared light may be provided. Accordingly, the infrared light reflected by the eye area of the user can be imaged by the imaging device.

Alternatively, when a head mount display (HMD) is worn on the head of the user U, the detecting unit 111 may detect the line of sight of the user U on the basis of an orientation of the HMD. Further, when a myoelectric sensor is worn on the body of the user U, the detecting unit 111 may detect the line of sight of the user U on the basis of the myoelectricity detected by the myoelectric sensor. Then, the detecting unit 111 calculates the line of sight of the user U as the designated vector, and detects the intersection point of the designated vector and the plane including the display area 171 as the designated position.

### [1-7. Hardware Configuration Examples]

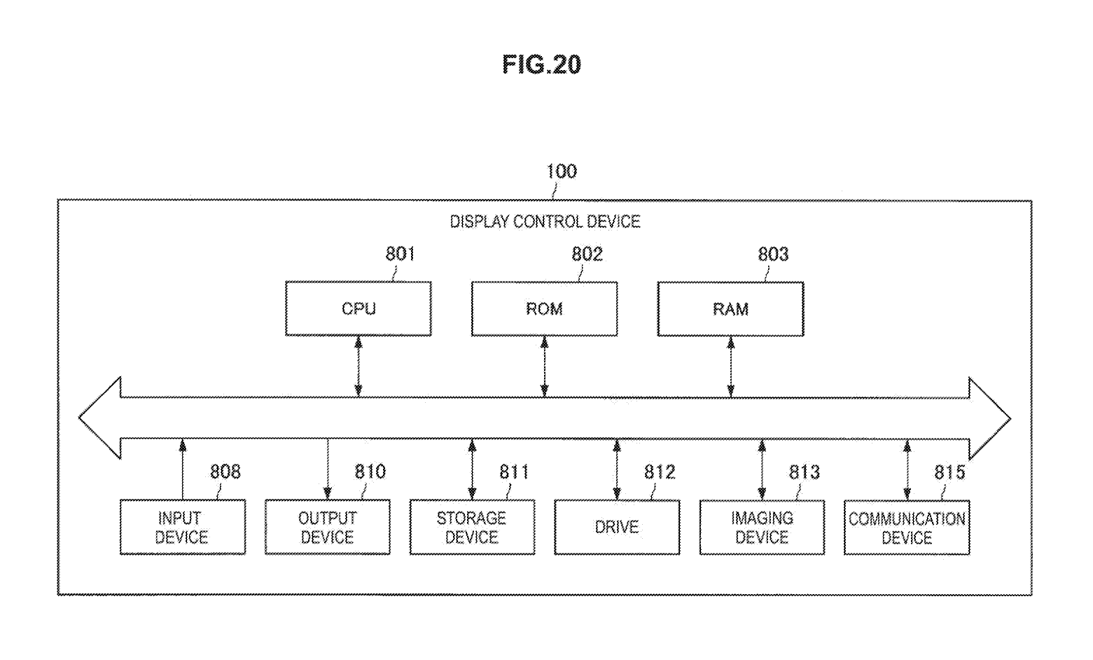

To continue, a hardware configuration example of the display control device 100 according to an embodiment of the present disclosure will be described. FIG. 20 is a figure which shows a hardware configuration example of the display control device 100 according to an embodiment of the present disclosure. However, the hardware configuration example shown in FIG. 20 merely shows an example of the hardware configuration of the display control device 100. Therefore, the hardware configuration of the display control device 100 is not limited to the example shown in FIG. 20.

As shown in FIG. 20, the display control device 100 includes a CPU (Central Processing Unit) 801, a ROM (Read Only Memory) 802, a RAM (Random Access Memory) 803, an input device 808, an output device 810, a storage device 811, a drive 812, an imaging device 813, and a communication device 815.

The CPU 801 functions as an operation processing device and a control device, and controls all the operations within the display control device 100 in accordance with various programs. Further, the CPU 801 may be a microprocessor. The ROM 802 stores programs and operation parameters used by the CPU 801. The RAM 803 temporarily stores programs used in the execution of the CPU 801, and parameters which arbitrary change in this execution. These sections are mutually connected by a host bus constituted from a CPU bus or the like.

The input device 808 includes an input section, such as a mouse, a keyboard, a touch panel, buttons, a microphone, switches or leavers, for a user to input information, and an input control circuit which generates an input signal on the basis of an input by the user, and outputs the input signal to the CPU 801. By operating this input device 808, it is possible for the user of the display control device 100 to input various data for the display control device 100 and to instruct the process operations.

The output device 810 includes, for example, a display device such as a liquid crystal display (LCD) device, an OLED (Organic Light Emitting Diode) device, or a lamp. In addition, the output device 810 includes a sound output device such as a speaker or headphones. For example, the display device displays an imaged image or a generated image. On the other hand, the sound output device converts sound data and outputs sounds.

The storage device 811 is an device for data storage constituted as an example of a storage section of the display control device 100. The storage device 811 may include a storage medium, a recording device which records data to the storage medium, a reading device which reads data from the storage medium, and an erasure device which erases data recorded in the storage medium. This storage device 811 stores programs executed by the CPU 801 and various data.

The drive 812 is a reader/writer for the storage medium, and is built into the display control device 100 or is externally attached. The drive 812 reads information recorded on a removable storage medium, such as a mounted magnetic disk, an optical disk, a magneto-optical disk, or a semiconductor memory, and outputs the information to the RAM 803. Further, the drive 812 can write information to the removable storage medium.

The imaging device 813 includes an imaging optical system such as a shooting lens which collects light and a zoom lens, and a signal conversion device such as a charge coupled device (CCD) and a complementary metal oxide semiconductor (CMOS). The imaging optical system collects light emitted from a subject to form a subject image at a signal converting unit, and the signal conversion device converts the formed subject image into an electrical image signal.

The communication device 815 is, for example, a communication interface constituted by a communication device or the like for connecting to a network. Further, the communication device 815 may be a communication device adaptive to wireless LAN (Local Area Network), a communication device adaptive to LTE (Long Term Evolution), or a wired communication device which performs wired communication. For example, it is possible for the communication device 815 to communicate with other devices via a network.

The exemplary hardware configuration of the display control device 100 according an embodiment of to the present disclosure has been described above.

### 2. Conclusion

As described above, according to an embodiment of the present disclosure, provided is a display control device 100 including a detecting unit 111 configured to detect an intersection point of a designated vector by a user and a plane including a display area 171 as a designated position and a display control unit 112 configured to perform display control on the basis of the designated position, in which the display control unit 112 performs predetermined display control when the designated position is outside the display area 171. According to such a configuration, when the position designated by the user is outside the display area 171, it is possible to give a feedback indicating that a position outside the display area 171 is designated to the user.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, when the detection accuracy by the detecting device 120 is not high, the object displayed on the display area 171 is likely to vibrate finely, and thus it is unlikely to be seen by the user. In this regard, the display control unit 112 may suppress the vibration of the object by applying a filter to the object displayed on the display area 171. Alternatively, it is possible to enable the user to feel that the vibration of the object is suppressed by adding an afterimage to the object displayed on the display area 171.

Further, a program for causing hardware, such as a CPU, ROM and RAM built into a computer, to exhibit functions similar to the configuration included in the above described display control device 100 can be created. Further, a recording medium can also be provided which records these programs and is capable of performing reading to the computer.

In addition, for example, operations of the display control device 100 need not always be performed in the temporal order described in a flowchart. For example, operations of the display control device 100 may be performed in a different order from the order described in the flowchart, or at least a part of the operations described in the flowchart may be performed in parallel.

Further, the effects described in this specification are merely illustrative or exemplified effects, and are not limitative. That is, with or in the place of the above effects, the technology according to the present disclosure may achieve other effects that are clear to those skilled in the art on the basis of the description of this specification.

Additionally, the present technology may also be configured as below.

(1)

A display control device including:

a detecting unit configured to detect an intersection point of a vector designated by a user and a plane including a display area as a designated position; and

a display control unit configured to perform display control on the basis of the designated position,

in which the display control unit performs predetermined display control in a case where the designated position is outside the display area.

(2)

The display control device according to (1),

in which the display control unit causes a predetermined object to be displayed on the display area in the case where the designated position is outside the display area.

(3)

The display control device according to (2),

in which the display control unit causes the predetermined object to be displayed at an end portion of the display area in the case where the designated position is outside the display area.

(4)

The display control device according to (3),

in which the display control unit causes the predetermined object to be displayed at an intersection point of the end portion of the display area and a line segment connecting a predetermined position of the display area with the designated position in the case where the designated position is outside the display area.

(5)

The display control device according to any one of (2) to (4),

in which the display control unit changes the predetermined object in accordance with the designated position.

(6)

The display control device according to (5),

in which the display control unit changes a size of the predetermined object in accordance with the designated position.

(7)

The display control device according to (5),

in which the display control unit changes a shape of the predetermined object in accordance with the designated position.

(8)

The display control device according to (5),

in which the display control unit changes a color of the predetermined object in accordance with the designated position.

(9)

The display control device according to (1),

in which the display control unit scrolls content of the display area on the basis of the designated position in the case where the designated position is outside the display area.

(10)

The display control device according to (9),

in which the display control unit scrolls the content on the basis of a direction of the designated position with reference to a predetermined position of the display area in the case where the designated position is outside the display area.

(11)

The display control device according to (9),

in which the display control unit scrolls the content at a speed corresponding to a distance between a predetermined position of the display area and the designated position in the case where the designated position is outside the display area.

(12)

The display control device according to (1),

in which the display control unit switches content of the display area on the basis of the designated position in the case where the designated position is outside the display area.

(13)

The display control device according to (1),

in which the display control unit performs a drag operation on the basis of movement of the designated position in a case where the designated position is moved from a position inside the display area to a position outside the display area.

(14)

The display control device according to (1),

in which the display control unit performs a pinch-in operation or a pinch-out operation on the basis of movement of each of a plurality of designated positions in a case where each of the plurality of designated positions is moved between a position inside the display area and a position outside the display area.

(15)

The display control device according to (1),

in which the display control unit corrects the designated position in the case where the designated position is outside the display area.

(16)

The display control device according to (15),

in which the display control unit corrects the designated position to an intersection point of a line segment connecting a predetermined position of the display area with the designated position and an end portion of the display area when the designated position is outside the display area.

(17)

A display control method including:

detecting an intersection point of a vector designated by a user and a plane including a display area as a designated position;

performing display control on the basis of the designated position; and

performing predetermined display control is performed in a case where the designated position is outside the display area.

(18)

A computer readable recording medium having a program stored therein, the program causing a computer to function as a display control device including

a detecting unit configured to detect an intersection point of a vector designated by a user and a plane including a display area as a designated position, and

a display control unit configured to perform display control on the basis of the designated position,

in which the display control unit performs predetermined display control in a case where the designated position is outside the display area.

### REFERENCE SIGNS LIST

10 information processing system
100 display control device
110 control unit
111 detecting unit
112 display control unit
113 executing unit
120 detecting device
130 storage unit
170 display device
171 display area
Ar correction area
B1, B2 object
C1 to C6 content
D (D1, D2) distance
Pc center position
Pd designated position
Pe intersection point
Pt1 to Pt4 designated position
T1 intersection point
T2 intersection point
U user
V designated vector
X intersection point

1. A display control device comprising:
a detecting unit configured to detect an intersection point of a vector designated by a user and a plane including a display area as a designated position; and
a display control unit configured to perform display control on the basis of the designated position,
wherein the display control unit performs predetermined display control in a case where the designated position is outside the display area.

2. The display control device according to claim 1,
wherein the display control unit causes a predetermined object to be displayed on the display area in the case where the designated position is outside the display area.

3. The display control device according to claim 2,
wherein the display control unit causes the predetermined object to be displayed at an end portion of the display area in the case where the designated position is outside the display area.

4. The display control device according to claim 3,
wherein the display control unit causes the predetermined object to be displayed at an intersection point of the end portion of the display area and a line segment connecting a predetermined position of the display area with the designated position in the case where the designated position is outside the display area.

5. The display control device according to claim 2,
wherein the display control unit changes the predetermined object in accordance with the designated position.

6. The display control device according to claim 5,
wherein the display control unit changes a size of the predetermined object in accordance with the designated position.

7. The display control device according to claim 5,
wherein the display control unit changes a shape of the predetermined object in accordance with the designated position.

8. The display control device according to claim 5,
wherein the display control unit changes a color of the predetermined object in accordance with the designated position.

9. The display control device according to claim 1,
wherein the display control unit scrolls content of the display area on the basis of the designated position in the case where the designated position is outside the display area.

10. The display control device according to claim 9,
wherein the display control unit scrolls the content on the basis of a direction of the designated position with reference to a predetermined position of the display area in the case where the designated position is outside the display area.

11. The display control device according to claim 9,
wherein the display control unit scrolls the content at a speed corresponding to a distance between a predetermined position of the display area and the designated position in the case where the designated position is outside the display area.

12. The display control device according to claim 1,
wherein the display control unit switches content of the display area on the basis of the designated position in the case where the designated position is outside the display area.

13. The display control device according to claim 1,
wherein the display control unit performs a drag operation on the basis of movement of the designated position in a case where the designated position is moved from a position inside the display area to a position outside the display area.

14. The display control device according to claim 1,
wherein the display control unit performs a pinch-in operation or a pinch-out operation on the basis of movement of each of a plurality of designated positions in a case where each of the plurality of designated positions is moved between a position inside the display area and a position outside the display area.

15. The display control device according to claim 1,
wherein the display control unit corrects the designated position in the case where the designated position is outside the display area.

16. The display control device according to claim 15,
wherein the display control unit corrects the designated position to an intersection point of a line segment connecting a predetermined position of the display area with the designated position and an end portion of the display area when the designated position is outside the display area.

17. A display control method comprising:
detecting an intersection point of a vector designated by a user and a plane including a display area as a designated position;
performing display control on the basis of the designated position; and
performing predetermined display control is performed in a case where the designated position is outside the display area.

18. A computer readable recording medium having a program stored therein, the program causing a computer to function as a display control device including
a detecting unit configured to detect an intersection point of a vector designated by a user and a plane including a display area as a designated position, and
a display control unit configured to perform display control on the basis of the designated position,
wherein the display control unit performs predetermined display control in a case where the designated position is outside the display area.
